(19) United States
(12) Patent Application Publication
(10) Pub. No.: US 2021/0226310 A1
(43) Pub. Date: Jul. 22, 2021

(54) A Cavity Filter

(71) Applicant: Nokia Solutions and Networks Oy, Espoo (FI)

(72) Inventors: Shouli JIA, Zhejiang (CN); Lipeng NIE, Zhejiang (CN); Hongjun ZHAO, Zhejiang (CN)

(21) Appl. No.: 15/734,299

(22) PCT Filed: Jun. 4, 2018
(86) PCT No.: PCT/CN2018/089786

§ 371 Date: Dec. 2, 2020

(51) Int. Cl. H01P 1/207; H01Q 1/50; H01P 7/06

(52) U.S. Cl. CPC H01P 1/207; H01P 7/06; H01Q 1/50

(57) ABSTRACT

A cavity filter including a housing, defining a cavity; and a planar resonator arrangement including multiple planar resonators that are arranged in a common plane inside the cavity, wherein the multiple planar resonators include at least: a first planar resonator including a first elongate planar lead terminating at a first planar head, and a second planar resonator including a second elongate planar lead terminating at a second planar head, wherein the first resonator and the second resonator are immediately adjacent and wherein the first elongate planar lead, the first planar head, the second elongate planar lead and the second planar head extend within the common plane.

### TECHNOLOGICAL FIELD

Embodiments of the present disclosure relate to a cavity filter.

### BACKGROUND

A cavity filter is a resonant circuit that only allows certain frequencies of electromagnetic waves to pass. A cavity filter comprises one or more resonators inside a conductive housing with input and output ports to the housing.

Cavity filters may comprise tuning elements that allow the filter to have a high Q at a desired resonant frequency.

In some examples, the cavity comprises a plurality of sub-cavities each of which comprises a three-dimensional resonator element and which are interconnected via coupling elements such as irises or apertures. While such cavity filters have good performance characteristics, they may be of a large volume and heavy.

### BRIEF SUMMARY

According to various, but not necessarily all, embodiments there is provided a cavity filter comprising: a housing, defining a cavity; and a planar resonator arrangement comprising multiple planar resonators that are arranged in a common plane inside the cavity, wherein the multiple planar resonators include at least: a first planar resonator comprising a first elongate planar lead terminating at a first planar head, and a second planar resonator comprising a second elongate planar lead terminating at a second planar head, wherein the first resonator and the second resonator are immediately adjacent and wherein the first elongate planar lead, the first planar head, the second elongate planar lead and the second planar head extend within the common plane.

In some but not necessarily all examples, the first planar resonator is a cantilever that is anchored by the first elongate planar lead and that suspends the first planar head within the cavity, and wherein the second planar resonator is a cantilever that is anchored by the second elongate planar lead and that suspends the second planar head within the cavity.

In some but not necessarily all examples, the first planar resonator is a cantilever that is anchored by the first elongate planar lead and that suspends the first planar head within the cavity, wherein the first planar head is supported by only the first elongate planar lead at a first fixed position within the cavity and wherein the second planar resonator is a cantilever that is anchored by the second elongate planar lead and that suspends the second planar head within the cavity, wherein the second planar head is supported by only the second elongate planar lead at a second fixed position within the cavity.

In some but not necessarily all examples, the housing comprises at least a first housing component defining a first part of the cavity and a second housing component defining a second part of the cavity, wherein the first part of the cavity and the second part of the cavity are separated by the common plane; and wherein the planar resonator arrangement is secured to the first housing and the second housing to suspend planar heads of the multiple planar resonators in the common plane between the first part of the cavity and the second part of the cavity.

In some but not necessarily all examples, the common plane bi-sects the cavity.

In some but not necessarily all examples, the first planar head and the second planar head are immediately adjacent and separated by a first gap and wherein the first elongate planar lead and the second elongate planar lead are immediately adjacent and separated by a second gap.

In some but not necessarily all examples, the apparatus is configured to operate at a resonant frequency having an associated resonant wavelength, wherein the first planar resonator has a first length measured in the common plane from an extremity of the first elongate planar lead, along the first elongate planar lead and through first planar head to a furthest extremity of the first planar head that is less than one quarter the resonant wavelength and wherein the second planar resonator has a second length measured in the common plane from an extremity of the second elongate planar lead, along the second elongate planar lead and through second planar head to a furthest extremity of the second planar head that is less than one quarter the resonant wavelength.

In some but not necessarily all examples, the apparatus is configured to operate at a resonant frequency having an associated resonant wavelength, wherein the first planar head and the second planar head are immediately adjacent and separated by a first gap, wherein the size of the first planar head and the size of the second planar head are configured to control an electrical length of the first planar resonator and an electrical length of the second planar resonator to be substantially one quarter the resonant wavelength.

In some but not necessarily all examples, the planar resonator arrangement comprises multiple planar resonators that each comprise an elongate planar lead terminating at a planar head, wherein the planar heads are arranged as a regularly spaced array in the common plane.

In some but not necessarily all examples, the apparatus comprises at least one deformable tuning element that is adjacent the first planar head and, in response to a deformation, is configured to modify a gap, in the common plane, between the at least one deformable tuning element and the first planar head. The at least one deformable tuning element may be a deformable side portion or a deformable element extending, as a cantilever in the common plane, from the housing towards the first planar head.

In some but not necessarily all examples, the housing comprises at least a first housing component defining a first part of the cavity and a second housing component defining a second part of the cavity, and the planar resonator arrangement is a component that is separable, as an intact component, from the first housing component and the second housing component and that is placed between the first housing component and second housing component. In some but not necessarily all examples, the planar resonator arrangement comprises an outer frame, defining a plane, and the multiple planar resonators extending from the frame and lying in the plane.

In some but not necessarily all examples, the planar resonator arrangement is formed from a sheet of metal.

In some but not necessarily all examples, the housing, comprises multiple cavities, wherein each of the cavities of the multiple cavities comprises a planar resonator arrangement comprising multiple planar resonators that are arranged in a common plane inside that cavity, wherein the multiple planar resonators include at least: a first planar resonator comprising a first elongate planar lead terminating at a first planar head, a second planar resonator comprising a second elongate planar lead terminating at a second planar head, wherein the first resonator and the second resonator are immediately adjacent and wherein the first elongate planar lead, the first planar head, the second elongate planar lead and the second planar head extend within the common plane.

In some but not necessarily all examples, the apparatus comprises an additional housing, defining an additional cavity, the additional housing comprising at least a first additional housing component defining a first part of the additional cavity and a second additional housing component defining a second part of the additional cavity; and an additional planar resonator arrangement comprising multiple additional resonators that are arranged in an additional common plane between the first additional part of the additional cavity and the second additional part of the additional cavity, wherein the housing and the additional housing are stacked so that the common plane and the additional common plane are parallel but separated.

According to various, but not necessarily all, embodiments there is provided a base station comprising: one or more cavity filters as described, and an antenna arrangement comprising multiple radiator elements arranged in a two-dimensional array comprising multiple, parallel, one-dimensional sub arrays, wherein each one-dimensional sub-array is associated with a cavity of a cavity filter.

According to various, but not necessarily all, embodiments there is provided an apparatus comprising: a housing, defining a cavity; and a planar resonator arrangement comprising multiple planar resonators that are arranged in a common plane inside the cavity, wherein the multiple planar resonators include at least: a first planar resonator comprising a first elongate planar lead terminating at a first planar head, and a second planar resonator comprising a second elongate planar lead terminating at a second planar head, wherein the first resonator and the second resonator are immediately adjacent and wherein the first elongate planar lead, the first planar head, the second elongate planar lead and the second planar head extend within the common plane; and an antenna arrangement comprising multiple radiator elements arranged in a two-dimensional array comprising multiple, parallel, one-dimensional sub arrays, wherein each one-dimensional sub-array is associated with a cavity of a cavity filter.

According to various, but not necessarily all, embodiments there is provided examples as claimed in the appended claims.

### BRIEF DESCRIPTION

Some example embodiments will now be described with reference to the accompanying drawings in which:

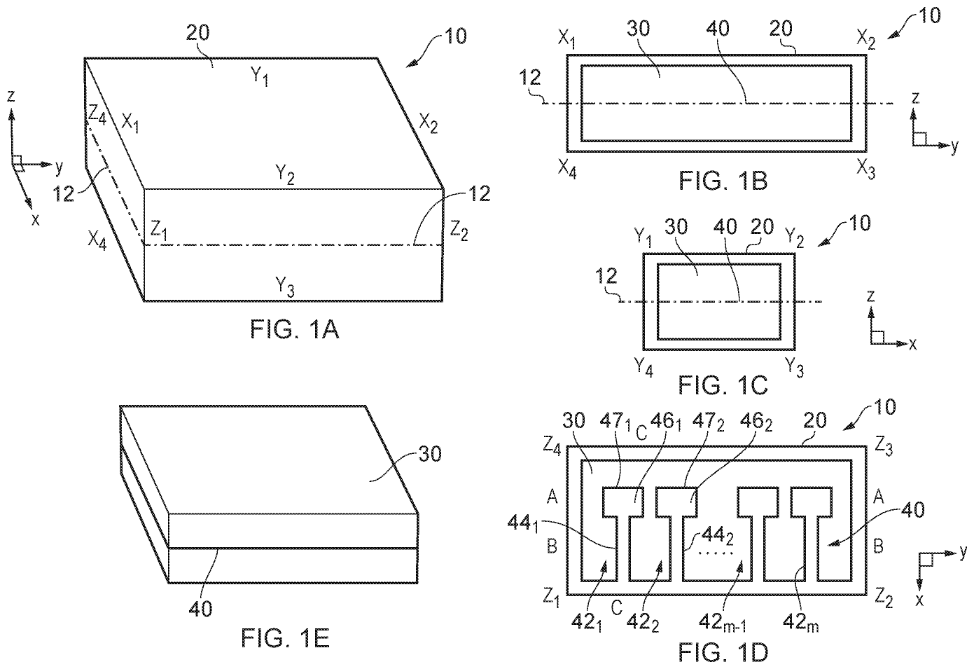

FIG. 1A to 1E show an example embodiment of the subject matter described herein;

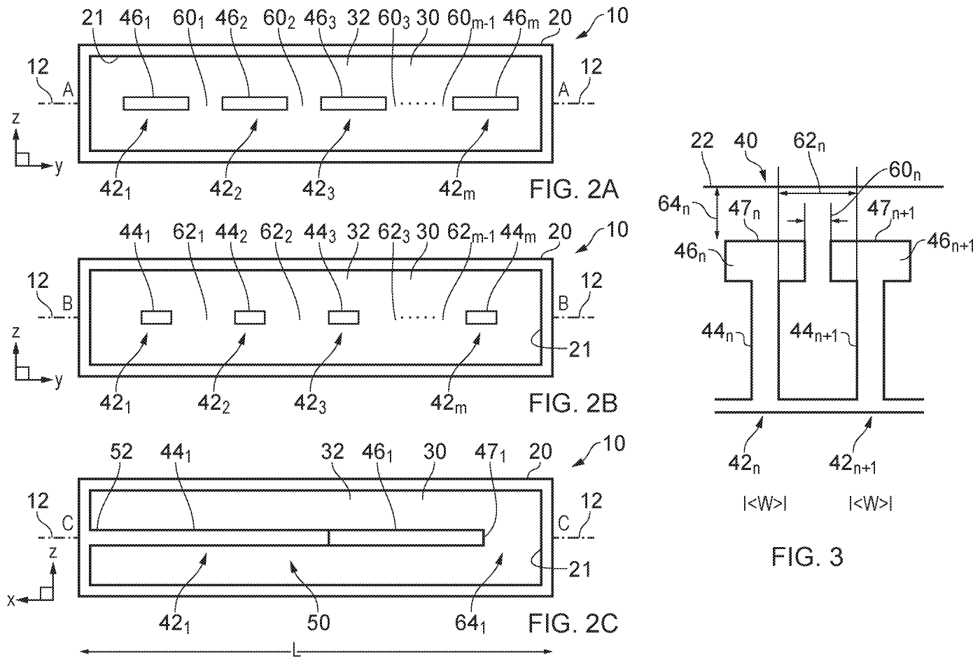

FIG. 2A to 2C shows another example embodiment of the subject matter described herein;

FIG. 3 shows an example embodiment of the subject matter described herein;

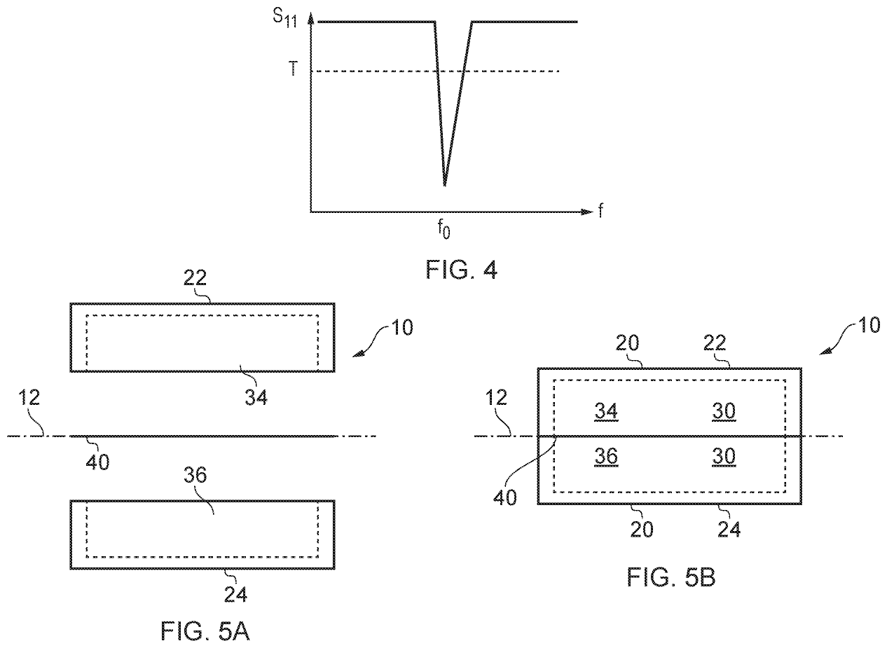

FIG. 4 shows another example embodiment of the subject matter described herein;

FIG. 5A to 5B show an example embodiment of the subject matter described herein;

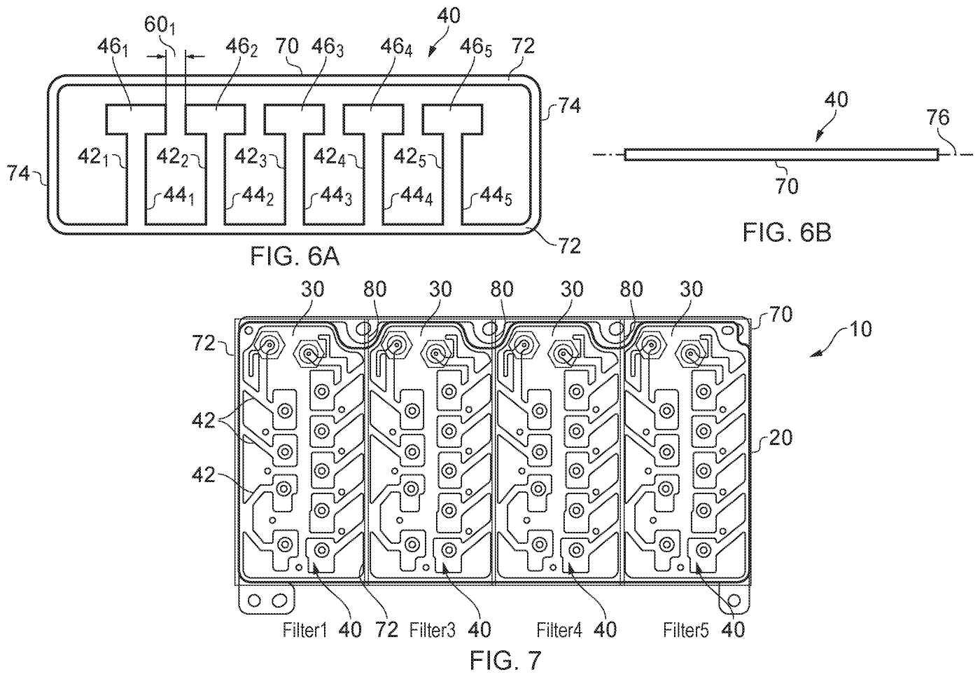

FIG. 6A to 6B show another example embodiment of the subject matter described herein;

FIG. 7 shows an example embodiment of the subject matter described herein;

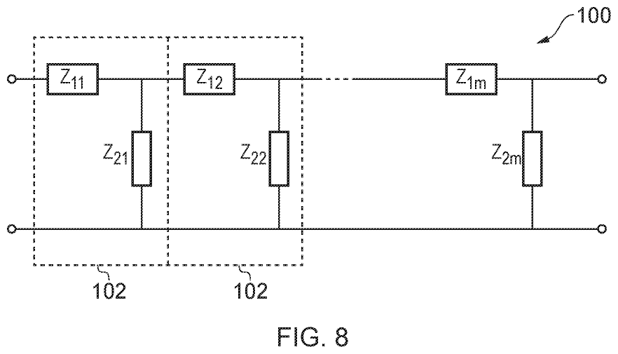

FIG. 8 shows another example embodiment of the subject matter described herein;

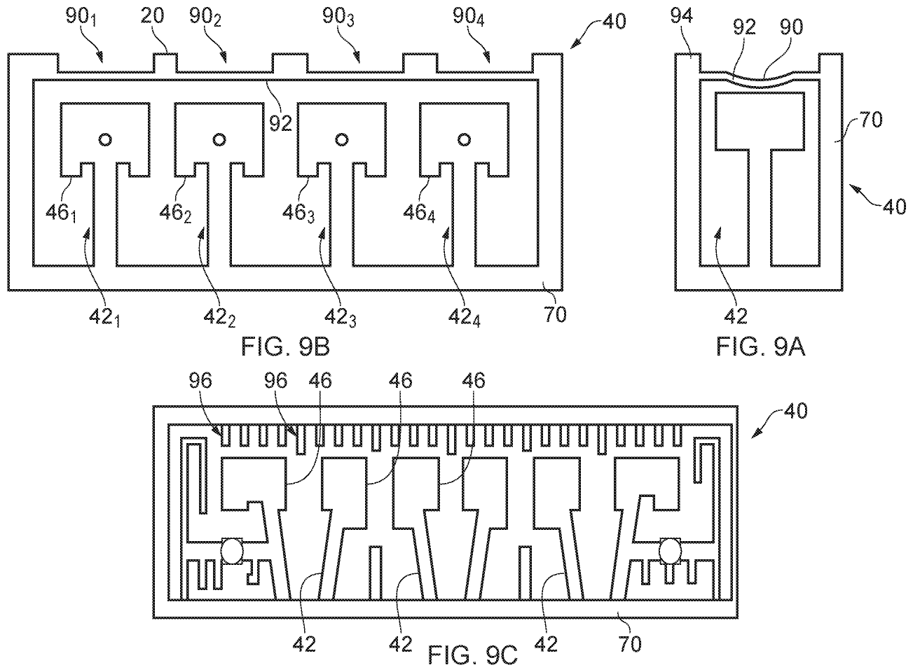

FIG. 9A to 9C show an example embodiment of the subject matter described herein;

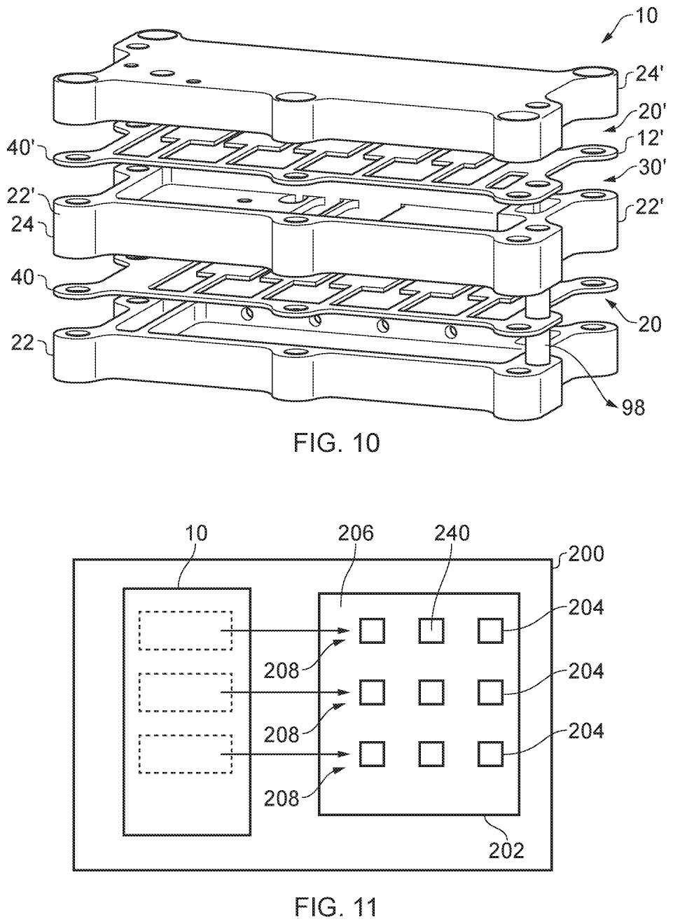

FIG. 10 shows another example embodiment of the subject matter described herein;

FIG. 11 shows another example embodiment of the subject matter described herein.

### DEFINITIONS

“Housing” is a structure that houses something and at least partially covers and protects it.

“Cavity” is a hollow space. In some examples it may be an empty void filled with air. In other examples it may be filled with a different dielectric.

“Planar” is an adjective that describes something that is substantially in a two-dimensional flat plane. Cartesian and Euclidian planes are examples of flat planes.

“Resonator” is a structure that supports electromagnetic resonance. It may also be referred to as an electromagnetic resonator. It has an associated capacitance and inductance.

“Planar resonator arrangement” is a planar arrangement of resonators, that is, an arrangement that is planar.

“Planar resonator” is a resonator that is planar.

“A lead” is a physical interconnect.

“Head” is a terminating portion of a structure that is larger than an interconnecting neck portion.

“Immediately adjacent” means, when applied to objects, that they are not only neighbors but are nearest neighbors. In the context of resonators, it means that the resonators are separate and are not in contact and that they are nearest neighbors without any or any substantial intermediary conductive structure.

### DETAILED DESCRIPTION

The figures attached to this description describe various examples of cavity filters 10. The cavity filters 10 have certain features in common. For example, referring to FIGS. 1A to 1E, the cavity filter 10 comprises: a housing 20, defining a cavity 30; and a planar resonator arrangement 40 comprising multiple planar resonators 42 that are arranged in a common plane 12 inside the cavity 30 wherein the multiple planar resonators 42 include at least: the first planar resonator 42₁ comprising a first elongate planar lead 44₁ terminating at a first planar head 46₁ and a second planar resonator 42₂ comprising a second elongate planar lead 44₂ terminating at a second planar head 46₂. The first resonator 42₁ and the second resonator 42₂ are immediately adjacent. The first elongate planar lead 44₁, the first planar head 46₁, the second elongate planar lead 44₂ and the second planar head 46₂ extend within the common plane 12.

FIG. 1A illustrates an external view of the cavity filter 10. The housing 20 encloses, at least substantially, the planar resonator arrangement 40 (not shown in this figure) and the cavity 30 (not shown in this figure).

An orthogonal co-ordinate reference system is illustrated in FIG. 1A. The unit vector x extends in a widthwise direction, the unit vector y extends in a lengthwise direction and the unit vector z extends in a heightwise direction and, as is standard in a Cartesian coordinate system, z=x\hat{ }y, where A represents the vector cross-product.

FIG. 1B illustrates a cross-sectional view of the housing 20 through an X-plane that is normal to the unit vector x. FIG. 10 illustrates a cross-section through the housing 20 in a Y-plane that is normal to the unit vector y. FIG. 1D illustrates a cross-section through the housing 20 through a Z-plane that is normal to the unit vector z.

In this particular example, the cross-section shown in FIG. 1B is approximately one half way along a width of the housing 20, the cross-section shown in FIG. 10 is approximately one half way along a length of the housing 20 and the cross-section shown in FIG. 1D is approximately one half way along a height of the housing 20.

FIG. 1E schematically illustrates the shape and size of the cavity 30 and the position of the planar resonator arrangement 40, without the housing 20 being present.

In this example the housing 20 has a substantially cuboid exterior and a substantially cuboid cavity 30. However, the housing can have other shapes and the cavity 30 can have other shapes. The shape of the cavity 30 does not have to be a scaled version of the exterior of the housing 20, the shape of the housing 20 and the shape of the cavity can be independent.

The cross-section shown in FIG. 1D is in the common plane 12 and it illustrates the planar resonator arrangement 40 comprising multiple planar resonators 42 that are arranged in the common plane inside the cavity 30.

The arrangement 40 is planar and lies in the common plane 12. The resonators 42 are planar and lie in the common plane 12.

The first planar resonator 42₁ comprising a first elongate planar lead 44₁ terminating at a first planar head 46₁, and a second planar resonator 42₂ comprising a second elongate planar lead 44₂ terminating at a second planar head 46₂. There may be additional planar resonators and the FIG illustrates other planar resonators 42 each of which comprises an elongate planar lead 44 terminating at the planar head.

The leads 44 are physical interconnects to the heads 46. The leads 44 are planar and lie in the common plane 12. The leads 44 extend lengthwise more than widthwise and are consequently elongate. In some but not necessarily all examples a lead 44 has a constant width. A lead 44 can have straight or curved sides. Where a lead 44 has a constant width and straight (parallel) sides, the lead 44 can have a trapezoidal shape, as in the example illustrated where it has a rectangular shape.

In this example immediately adjacent leads 44 extend in parallel but this is not necessary in all examples. In this example, immediately adjacent leads 44 have parallel opposing sides but this is not necessary in all examples. In this example the leads 44 are of the same dimensions but this is not necessary in all examples.

The heads 46 are physical interconnected by the leads. The heads 46 are planar and lie in the common plane 12. A head 46 extends widthwise more than the interconnecting elongate lead 44. The lead 44 therefore forms a ‘neck’ for the head 46. A head 46 can extend widthwise more than lengthwise. In some but not necessarily all examples a head 46 has a constant width. A head 46 can have straight or curved sides. Where a head 46 has a constant width and straight (parallel) sides the head 46 can have a trapezoidal shape, as in the example illustrated, where it has a rectangular shape.

In this example immediately adjacent heads 46 extend in parallel length wise but this is not necessary in all examples. In this example immediately adjacent heads 46 extend in parallel width wise but this is not necessary in all examples. In this example, immediately adjacent leads 44 have parallel opposing sides but this is not necessary in all examples. In this example the heads 46 are of the same dimensions but this is not necessary in all examples.

It can be seen from FIG. 1D that the first resonator 42₁ and the second resonator 42₂ are immediately adjacent. The first resonator 42₁ and the second resonator 42₂ are separate and are not in contact and that they are nearest neighbors without any (or any substantial) intermediary conductive structure. The second resonator 42₂ is immediately adjacent a third resonator (not shown in this FIG). In general a nth resonator 42ₙ will be immediately adjacent both the preceding resonator 42ₙ₋₁ (if there is one) and the following resonator 42ₙ₊₁ (if there is one).

It can be appreciated from FIGS. 1B and 10 that the elongate planar leads 44 and the planar heads 46 of the multiple planar resonators 42 extend within the common plane 12.

FIGS. 2A, 2B and 2C illustrate further cross-sections through the housing 20. The planes of these cross-sections can best be understood from FIG. 1D. The cross-section illustrated in FIG. 2A is an X-plane that is normal to the unit vector x. The cross-section is orthogonal to the common plane 12 and passes through the planar heads 46 of the multiple planar resonators 42. The cross-section illustrated in FIG. 2B is an X-plane that is normal to the unit vector x. The cross-section is orthogonal to the common plane 12 and passes through the elongate planar leads 44 of the multiple planar resonators 42. The cross-section illustrated in FIG. 2C is a Z-plane that is normal to the unit vector z. The cross-section is orthogonal to the common plane 12 and passes through the first elongate planar lead 44₁ and the first planar head 46₁.

As can be seen from FIGS. 2A, 2B and 2C, the cavity 30 is filled with dielectric 32. The dielectric 32 may, for example, be the surrounding atmosphere of the cavity filter 10, for example air. Alternatively, the cavity 30 may be filled with one or more dielectric materials, for example, ceramic with low loss. At least the interior surface 21 of the housing 20, that defines the cavity 30, is conductive.

The multiple planar resonators 42 are configured to support electromagnetic resonance. In some examples they are conductive in that they are formed from a conductive material or are coated with a conductive material. In some, but not necessarily all, examples the conductive material may be a metal. A conductive coating may, for example, be copper, silver or hold. In some examples, one or more of the multiple planar resonators 42 are formed from steel with silver or copper plating.

In the example illustrated, the elongate planar leads provide a support for the respective planar heads 46 to which they are attached. The planar resonators 42 are cantilevers 50 that are anchored 52 by the elongate planar lead 44 and that suspend the attached planar head 46 within the cavity 30. The planar resonator 42 is consequently free at one end. The planar head 46 is supported by only the attached elongate planar lead 44 at a fixed position in the cavity 30. This is for example illustrated in FIG. 2C which illustrates the first planar resonator 42₁ is configured as a cantilever 50 that is anchored 52 by the first elongate planar lead 44₁ and that suspends the first planar head 46₁ within the cavity 30. The first planar head 46₁ is supported by only the first elongate planar lead 44₁ at a first fixed position within the cavity 30.

Although not illustrated in the figures, a similar configuration may exist for the second planar resonator 42₂. It too may be a cantilever that is anchored by the second elongate planar lead 44₂ and that suspends the second planar head 46₂ within the cavity 30. The second planar head 46₂ is supported by only the second elongate planar lead 44₂ at a second fixed position in the cavity 30.

As can be seen from FIGS. 1D and 2A, the first planar head 46₁ and the second planar head 46₂ are immediately adjacent and separated by a first gap 60₁. The second planar head 46₂ and a third planar head 46₃ are immediately adjacent and separated by a second gap 60₂. In general, as illustrated in FIG. 3, the nth planar head 46ₙ and a (n+1)th planar head 46ₙ₊₁ are immediately adjacent and separated by a gap 60ₙ. In some examples a gap 60 has a variable size (a width across the gap varies as one travels along the gap's length) and in other examples, the gap has a constant size (a width across the gap is constant as one travels along the gap's length)

As illustrated in FIG. 1D and FIG. 2B, the first elongate planar lead 44₁ and the second elongate planar lead 44₂ are immediately adjacent, for at least a portion of their lengths, and separated by a second gap 62₁ at that portion. The second elongate planar lead 44₂ and a third elongate planar lead 44₃ are immediately adjacent, for at least a portion of their lengths, and separated by a second gap 62₂ at that portion. In general, as illustrated in FIG. 3, the nth elongate planar lead 44ₙ and the (n+1)th elongate planar lead 44ₙ₊₁ are immediately adjacent, for at least a portion of their lengths, and separated by a second gap 62ₙ at that portion. In some examples a gap 62 has a variable size (a width across the gap varies as one travels along the gap's length) and in other examples, the gap 62 has a constant size (a width across the gap is constant as one travels along the gap's length).

As illustrated in FIG. 2C and FIG. 1D, a terminal portion 47₁ of the first planar head 46₁ is immediately adjacent the interior surface 21 of the housing 20 and separated therefrom by a third gap 64₁. The first planar head is an open-ended terminus of the first planar resonator 42₁ In general, as illustrated in FIG. 3, the terminal portion 47ₙ of the nth planar head 46ₙ is immediately adjacent the interior surface 21 of the housing 20 and separated therefrom by a third gap 64ₙ.

As illustrated in FIG. 4, the cavity filter 10 is configured to have a resonant frequency f₀. In this example, FIG. 4 illustrates the return loss S₁₁ of the cavity filter 10. The return loss has a minimum value at the resonant frequency f₀. The cavity filter 10 has an operational bandwidth B where the return loss is below a threshold value T. The cavity filter 10 is configured to control the resonant frequency f₀ and the operational bandwidth B. As is known to those skilled in the art, the resonant frequency f₀ has an associated resonant wavelength related to it by the speed of light. In some but not necessarily all examples, the cavity filter 10 has a Q-factor at a resonant frequency that is greater than 1×10\hat{ }3.

Referring back to FIG. 2C, the first planar resonator 42₁ has a first length L measured in the common plane 12 from an extremity of the first elongate planar lead 44₁ (for example at anchor 52), along the first elongate planar lead 44₁ and through the first planar head 46₁ to a furthest extremity 47₁ of the first planar head 46₁ that is less than one quarter of the resonant wavelength.

In this example, each of the planar resonators has a length, measured in the common plane 12 from an extremity 52 of the elongate planar lead 44, along the elongate planar lead 44 and through the attached planar head 46 to a furthest extremity 47 of the planar head 46, that is less than one quarter the resonant wavelength.

This has the advantage that the width of the housing cavity 10 can be small.

As previously illustrated in FIGS. 1D and 2A and as further illustrated in FIG. 3, the first planar head 46₁ and the second planar head 46₂ are immediately adjacent and separated by a first gap 60₁. The size, for example the width W, of the first planar head 46₁ and the size, for example the width W, of the second planar head 46₂ are configured to control the size of the first gap 60₁ and consequently control an electrical length of the first planar resonator 42₁ and an electrical length of the second planar resonator 42₂ to be substantially one quarter the resonant wavelength.

As is known to those skilled in the art, the resonant frequency of a cavity filter is determined by the complex impedance of the cavity filter. The complex impedance of the cavity filter can be configured by changing the inductance and/or capacitance associated with each planar resonator 42. This can be achieved by controlling the dimensions of the elongate planar leads 44 and of the planar heads 46 and by controlling the pitch between the planar resonators 42. In this way, it is possible to control the gap 62 between the adjacent planar leads 44, the gap 60 between adjacent planar heads and the gap 64 between the planar heads 66 and the housing 40. The control of these dimensions can be used to control the inductance and capacitance and consequently the resonant frequency and bandwidth of the cavity filter 10.

In the examples illustrated in the above-mentioned figures, the planar leads and the planar heads have been identical. However this is not necessarily the case. It is, for example, possible to separately vary the dimensions of one planar resonator 42 relative to another planar resonator, for example an adjacent planar resonator 42.

In the above examples, the elongate planar leads 44 have been illustrated as parallel. While this may be the case in some examples, it is not necessarily the case in all examples.

FIG. 5A and FIG. 5B illustrate an example of a cavity filter 10 as previously described. In this example the housing 20 comprises at least a first housing component 22 defining a first part 34 of the cavity 30 and a second housing component 24 defining a second part 36 of the cavity 30. FIG. 5A illustrates the cavity filter 10 in an unassembled configuration and FIG. 5B illustrates the cavity filter 10 in an assembled configuration.

The first part 34 of the cavity 30 and the second part 36 of the cavity 30 are separated by the common plane 12. Likewise the first housing component 22 and the second housing component 24 are separated by the common plane 12 in the assembled configuration (FIG. 5B).

The planar resonator arrangement 40 is positioned between the first housing component 22 and the second housing component 24 and lies in the common plane 12. The planar resonator arrangement 40, in the assembled configuration, is secured to the first housing component 22 and the second housing component 24 in the common plane 12 between the first part 34 of the cavity 30 and the second part 36 of the cavity 30. In this example, but not necessarily all examples, the cavity 30 of the cavity filter 10 is bisected by the common plane 12.

In some, but not necessarily all, examples, the planar resonator arrangement 40 is formed from a sheet of metal.

In at least some embodiments, the planar resonator arrangement 40 is a component that is separable, as an intact component, from the first housing component 22 and the second housing component 24 when it is in the assembled configuration, for example, by disassembling the cavity filter 10 as illustrated in FIG. 5A.

FIGS. 6A and 6B illustrate an example of a planar resonator arrangement 40. FIG. 6A is a plan view and FIG. 6B is a side view. In this example the planar resonator arrangement 40 comprises an outer frame 70 defining a plane 76. The multiple planar resonators 42 extend from the frame 70 and lie in the plane 76. FIG. 6A is an illustration of the planar resonator arrangement 40 in a direction from a viewpoint that is normal to the plane 76 and FIG. 6B illustrates the planar resonator arrangement 40 from a viewpoint that lies in the plane 76.

In this example, the frame 70 and the multiple planar resonators 42 may be formed from a single sheet of metal.

FIG. 7 illustrates an example of a cavity filter 10 as illustrated in previous examples. The planar resonator arrangement 40 comprises multiple planar resonators 42 that each comprise an elongate planar lead 44 terminating at a planar head 46.

In this example, but not necessarily all example, the planar heads 46 are arranged as a spaced array in the common plane 12. In this example, the planar heads 46 in a cavity 40 are arranged as a multi-column array (a two-column array). In one of the columns (right-hand side) the planar heads 46 are regularly spaced. In the other one of the columns (left-hand side) the planar heads 46 are not regularly spaced.

In the example illustrated in FIG. 6A, the planar heads are arranged in a one column array. The planar heads 46 are regularly spaced.

In the example of FIG. 7, the outer frame 70 for a cavity 30 is substantially rectangular comprising a pair of opposing longer sides 72 and a pair of opposing shorter sides 74. The planar resonator arrangement comprises multiple planar resonators 42. The multiple planar resonators 42 are part of a first set or a second set of a cavity 30. The first set of planar resonators (on the left) depend from one of a pair of opposing longer sides (left side) 72 and extend inwardly (towards the right in the figure) into the cavity 30. The second set of planar resonators (on the right) depend from the other one of that pair of opposing longer sides 72 (right side) and extend inwardly (towards the left in the figure) into the cavity 40.

FIG. 7 also illustrates a cavity filter 10 where the housing 20 defines multiple cavities 30. Each of the cavities may form a different filter. Each of the cavities comprises a planar resonator arrangement 40 comprising multiple planar resonators 42 that are arranged in a common plane 12 inside that cavity 30.

The multiple planar resonators 42 include at least a first planar resonator 42₁ comprising at least a first elongate planar lead 44₁ terminating at a first planar head 46₁ and a second planar resonator 42₂ comprising a second elongate planar lead 44₂ terminating at a second planar head 46₂.

As in the previous examples, the first resonator and the second resonator are mutually adjacent and the first elongate planar lead 44₁, the first planar head 46₁, the second elongate planar lead 44₂ and the second planar head 46₂ extend within the common plane 12.

In this example the planar resonator arrangements 40 of each different cavity are electromagnetically separated from the planar resonator arrangements 40 of the other cavities. Electromagnetic separations mean that there is no electromagnetic coupling or negligible electromagnetic coupling. They are therefore electromagnetically isolated from each other.

In some, but not necessarily all, examples, a conductive separator 80 may be positioned between but not touching a pair of adjacent ones of the planar resonator arrangements 40 and between the adjacent cavities 30. As is known to those in the art, the presence of a conductive separator operates as a Faraday cage providing electromagnetic isolation.

FIG. 8 illustrates a schematic illustration of one example of a cavity filter 10. In this example, the multiple planar resonators 42 of the planar resonator arrangement 40 is modelled as a ladder topology of cascade sections, each section Sₓ comprises a series impedance Z₁ₓ and a shunt impedance Z₂ₓ. One or more of the series impedances and/or the shunt impedances are dependent upon the spaced relationship of the planar resonators 42 to each other and to the housing 20. This model of the complex impedance of the cavity filter 10 provides some understanding as to how the cavity filter can be configured to have a particular resonant frequency and how that resonant frequency can be tuned. It will be appreciated that by changing one or more of the impedances it is possible to change the overall impedance of the cavity filter and thereby change its resonant frequency.

At the manufacturing stage, this may be achieved by determining the size, shape and pitch of the multiple planar resonators 42. However, it may be desirable to be able to tune the resonant frequency or other characteristics of the cavity filter 10 when it is in situ or after it has been manufactured. It would therefore be desirable for the cavity filter 10 to have a tuning arrangement that can adapt independently the series impedances and/or shunt impedances of one or more sections of the ladder topology. This may, for example, be achieved by adapting independently capacitive coupling between the housing 20 and one or more of the multiple resonator elements 42.

FIGS. 9A, 9B and 9C illustrate an example of a cavity filter 10 as previously described. The cavity filter 10 comprises at least one deformable tuning element 90 that is adjacent a planar head 46 of a planar resonator 42. The deformable tuning element 90 is configured, in response to a deformation, to modify the gap 64, in the common plane 12, between the deformable tuning element 90 and the planar head 46.

In the examples illustrated the deformable tuning element 90 is part of the frame 70 of the planar resonator arrangement 40. In other examples the deformable tuning element 90 is part of the housing 20.

The cavity filter 10 can comprises multiple deformable tuning elements 90. Each deformable element is immediately adjacent a planar head 46 of a planar resonator 42. There may be one or more deformable tuning elements 90 associated with each planar head 46.

The deformable tuning elements 90 are configured to be deformed to modify the gap 64, in the common plane 12, between the deformable tuning element 90 and the planar head 46. This changes the overall impedance of the cavity filter 10 and thereby change its resonant frequency.

In FIGS. 9A and 9B, there is one deformable tuning element 90 associated with each planar head 46. The deformable element 90 is a deformable portion 92 of a side 72 of the frame 70. An aperture in the housing 20 may allow a tool to be inserted from the exterior of the housing to deform the deformable tuning element 90.

In FIG. 9C the are multiple deformable tuning element 90 associated with each planar head 46. The deformable elements 90 are deformable extensions 96, extending as a cantilever in the common plane 12, from the frame 70 towards the associated planar head 46. The deformable extensions 96 are arranged in parallel and form a comb structure. The deformable extensions 96 may be regularly separated. The deformable extensions 96 may have different lengths, the differing lengths may form a periodic pattern. Apertures in the housing 20 may allow a tool to be inserted from the exterior of the housing to deform the deformable extensions 96.

FIG. 10 illustrates an example of a cavity filter 10 as previously described. In this example, the cavity filter comprises an additional housing 20′, defining an additional cavity 30′.

The additional housing 20′ comprises a first additional housing component 22′ defining a first part 34′ (not shown) of the additional cavity 30′ and a second additional housing component 24′ defining a second part 36′ of the additional cavity 30′. The arrangement is the same as that described previously with reference to FIGS. 5A and 5B but with additional housing components 22′, 24′ and additional planar resonator arrangement 40′ instead of housing components 22, 24 and additional planar resonator arrangement 40.

The additional planar resonator arrangement 40′ comprises multiple additional resonators 42 that are arranged in an additional common plane 12′ between the first additional part 22′ of the additional cavity 20′ and the second additional part 24′ of the additional cavity 20′.

The description of the features of the housing 20, additional planar resonator 40 and other aspects previously provided is also relevant as a description of the features of the additional housing 20′ and additional planar resonator arrangement 40′ and its equivalent aspects.

The housing 20 and the additional housing 20′ are stacked so that the common plane 12 and the additional common plane 12′ are parallel but separated.

In the example illustrated the housing component 22 of the housing 20 and the first additional housing component 22′ of the additional housing 20′ are integrated as a single component.

Guides 98 may be provided to help alignment and assembly of the housing 20 and the additional housing 20′ in a stacked arrangement.

In some, but not necessarily all example, the cavity 30 and the additional cavity 30′ are coupled via at least one coupler (not illustrated).

FIG. 11 illustrates an example of an apparatus 200 comprising one or more cavity filters 10. The apparatus 200 may be a node in a wireless network or system, such as a wireless mobile communication network or system, satellite communication network or system, television broadcast network or system, a modulated radio broadcast network or system, or a RADAR network or system.

This example illustrates an apparatus 200 comprising one or more cavity filters 10 and an antenna arrangement 202.

This example illustrates a base station 200 of a mobile cellular communications network comprising one or more cavity filters 10 and an antenna arrangement 202.

In this example, but not necessarily all examples the antenna arrangement comprises multiple radiator elements 204 arranged in a two-dimensional array 206 comprising multiple, parallel, one-dimensional sub arrays 208.

In this example, but not necessarily all examples each one-dimensional sub-array 208 is associated with a cavity 30 (and associated planar resonator arrangement 40) of a cavity filter 10. This arrangement may be used for massive multiple input multiple output.

Where a structural feature has been described, it may be replaced by means for performing one or more of the functions of the structural feature whether that function or those functions are explicitly or implicitly described.

The operational frequency B may be within or cover (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); global positioning system (GPS) (1570.42-1580.42 MHz); US—Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting —handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz) and frequency bands for 5G.

A frequency band over which an antenna can efficiently operate is a frequency range where the antenna's return loss is less than an operational threshold. For example, efficient operation may occur when the antenna's return loss S11 is better than (that is, less than) −10 dB or −14 dB.

An operational resonant mode (operational bandwidth) of a radiating element may be defined as where the return loss S11 of the radiating element is better than an operational threshold T such as, for example, −10 or −14 dB

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although embodiments have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain embodiments, those features may also be present in other embodiments whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer and exclusive meaning.

The presence of a feature (or combination of features) in a claim is a reference to that feature) or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. A cavity filter comprising:
a housing, defining a cavity; and
a planar resonator arrangement comprising multiple planar resonators that are arranged in a common plane inside the cavity, wherein the multiple planar resonators include at least:
a first planar resonator comprising a first elongate planar lead terminating at a first planar head, and
a second planar resonator comprising a second elongate planar lead terminating at a second planar head,
wherein the first resonator and the second resonator are immediately adjacent and wherein the first elongate planar lead, the first planar head, the second elongate planar lead and the second planar head extend within the common plane.

2. A cavity filter as claimed in claim 1, wherein the first planar resonator is a cantilever that is anchored by the first elongate planar lead and that suspends the first planar head within the cavity, wherein the first planar head is supported by only the first elongate planar lead at a first fixed position within the cavity and wherein the second planar resonator is a cantilever that is anchored by the second elongate planar lead and that suspends the second planar head within the cavity, wherein the second planar head is supported by only the second elongate planar lead at a second fixed position within the cavity.

3. A cavity filter as claimed in claim 1, wherein the housing comprises at least a first housing component defining a first part of the cavity and a second housing component defining a second part of the cavity, wherein the first part of the cavity and the second part of the cavity are separated by the common plane; and wherein the planar resonator arrangement is secured to the first housing and the second housing to suspend planar heads of the multiple planar resonators in the common plane between the first part of the cavity and the second part of the cavity.

4. A cavity filter as claimed in claim 1, wherein the common plane bisects the cavity.

5. A cavity filter as claimed in claim 1, wherein the first planar head and the second planar head are immediately adjacent and separated by a first gap and wherein the first elongate planar lead and the second elongate planar lead are immediately adjacent and separated by a second gap.

6. A cavity filter as claimed in claim 1, configured to operate at a resonant frequency having an associated resonant wavelength,
wherein the first planar resonator has a first length measured in the common plane from an extremity of the first elongate planar lead, along the first elongate planar lead and through first planar head to a furthest extremity of the first planar head that is less than one quarter the resonant wavelength and
wherein the second planar resonator has a second length measured in the common plane from an extremity of the second elongate planar lead, along the second elongate planar lead and through second planar head to a furthest extremity of the second planar head that is less than one quarter the resonant wavelength.

7. A cavity filter as claimed in claim 1, configured to operate at a resonant frequency having an associated resonant wavelength,
wherein the first planar head and the second planar head are immediately adjacent and separated by a first gap, wherein the size of the first planar head and the size of the second planar head are configured to control an electrical length of the first planar resonator and an electrical length of the second planar resonator to be substantially one quarter the resonant wavelength.

8. A cavity filter as claimed in claim 1, wherein the planar resonator arrangement comprises multiple planar resonators that each comprise an elongate planar lead terminating at a planar head, wherein the planar heads are arranged as a regularly spaced array in the common plane.

9. A cavity filter as claimed in claim 1, comprising at least one deformable tuning element that is adjacent the first planar head and, in response to a deformation, is configured to modify a gap, in the common plane, between the at least one deformable tuning element and the first planar head.

10. A cavity filter as claimed in claim 9, wherein the at least one deformable tuning element is a deformable side portion or wherein the at least one deformable tuning element is a deformable element extending, as a cantilever in the common plane, from the housing towards the first planar head.

11. A cavity filter as claimed in claim 1, wherein the housing comprises at least a first housing component defining a first part of the cavity and a second housing component defining a second part of the cavity, wherein the planar resonator arrangement is a component that is separable, as an intact component, from the first housing component and the second housing component and that is placed between the first housing component and second housing component and wherein the planar resonator arrangement comprises an outer frame, defining a plane, and the multiple planar resonators extending from the frame and lying in the plane.

12. A cavity filter as claimed in claim 1, wherein the planar resonator arrangement is formed from a sheet of metal.

13. A cavity filter as claimed in claim 1 wherein the housing, comprises multiple cavities, wherein each of the cavities of the multiple cavities comprises a planar resonator arrangement comprising multiple planar resonators that are arranged in a common plane inside that cavity, wherein the multiple planar resonators include at least:
a first planar resonator comprising a first elongate planar lead terminating at a first planar head,
a second planar resonator comprising a second elongate planar lead terminating at a second planar head,
wherein the first resonator and the second resonator are immediately adjacent and wherein the first elongate planar lead, the first planar head, the second elongate planar lead and the second planar head extend within the common plane.

14. A cavity filter as claimed in claim 1 comprising:
an additional housing, defining an additional cavity, the additional housing comprising at least a first additional housing component defining a first part of the additional cavity and a second additional housing component defining a second part of the additional cavity; and
an additional planar resonator arrangement comprising multiple additional resonators that are arranged in an additional common plane between the first additional part of the additional cavity and the second additional part of the additional cavity, wherein the housing and the additional housing are stacked so that the common plane and the additional common plane are parallel but separated.

15. An apparatus comprising: one or more cavity filters as claimed in claim 1; an antenna arrangement comprising multiple radiator elements arranged in a two-dimensional array comprising multiple, parallel, one-dimensional sub arrays, wherein each one-dimensional sub-array is associated with a cavity of a cavity filter.

16. An apparatus as claimed in claim 15 configured as a node for a wireless network or system, a wireless mobile communication network or system, a satellite communication network or system, a television broadcast network or system, a modulated radio broadcast network or system, or a RADAR network or system.

17. An apparatus comprising:
a housing, defining a cavity; and
a planar resonator arrangement comprising multiple planar resonators that are arranged in a common plane inside the cavity, wherein the multiple planar resonators include at least:
a first planar resonator comprising a first elongate planar lead terminating at a first planar head, and
a second planar resonator comprising a second elongate planar lead terminating at a second planar head,
wherein the first resonator and the second resonator are immediately adjacent and wherein the first elongate planar lead, the first planar head, the second elongate planar lead and the second planar head extend within the common plane; and an antenna arrangement comprising multiple radiator elements arranged in a two-dimensional array comprising multiple, parallel, one-dimensional sub arrays, wherein each one-dimensional sub-array is associated with a cavity of a cavity filter.
